(19) United States
(12) Patent Application Publication
(10) Pub. No.: US 2016/0320260 A1
(43) Pub. Date: Nov. 3, 2016

(54) AUTOMATIC WHEEL BALANCE WEIGHT ATTACHING SYSTEM

(71) Applicant: HYUNDAI MOTOR COMPANY, Seoul (KR)

(72) Inventor: Junhong Lim, Seoul (KR)

(73) Assignee: HYUNDAI MOTOR COMPANY, Seoul (KR)

(21) Appl. No.: 14/856,660

(22) Filed: Sep. 17, 2015

(30) Foreign Application Priority Data
Apr. 30, 2015 (KR) 10 2015 0061665

(51) Int. Cl. G01M 1/32

(52) U.S. Cl. CPC G01M 1/32

(57) ABSTRACT

The present disclosed provides an automatic wheel balance weight attaching system. The automatic wheel balance weight attaching system includes: a weight supplying apparatus supplying a balance weight; a weight cutting apparatus cutting the balance weight supplied from the weight supplying apparatus at a predetermined length; a wheel loading apparatus loading a wheel to a preset position; and a weight attaching apparatus attaching the cut balance weight to one side of an inner peripheral surface of the loaded wheel.

### CROSS-REFERENCE TO RELATED APPLICATION

This application claims the benefit of Korean Patent Application No. 10-2015-0061665, filed on Apr. 30, 2015, which is herein incorporated by reference in its entirety.

### FIELD

The present disclosure relates to an automatic wheel balance weight attaching system. More particularly, the present disclosure relates to a automatic wheel balance weight attaching system to attach a balance weight onto a wheel.

### BACKGROUND

The statements in this section merely provide background information related to the present disclosure and may not constitute prior art.

Generally, when a tire wheel of a vehicle has a portion in which a weight is unbalanced, vibrations are generated due to centrifugal force depending on rotation, such that noise, one-sided wear of a tire, a shaking phenomenon of a handle, and the like, are caused. Since the centrifugal force is in proportion to a rotation speed, in the case in which the vehicle is driven at a high speed, when an unbalance is present in the wheel, vibrations are increased. Therefore, the wheel should be accurately balanced.

The balance of the wheel is divided into a static balance and a dynamic balance depending on a feature thereof. When the wheel is statically unbalanced, the wheel vertically vibrates, and when the wheel is dynamically unbalanced, the wheel horizontally shakes.

In order to correct the unbalance of the wheel of the vehicle described above, a balance weight having an appropriate weight should be installed at any place (on a side that is opposite to a portion in which a weight unbalance is generated) of an edge of the wheel to generate centrifugal force in an opposite direction, thereby balancing the wheel.

The balance weight as described above may be divided into a clip-type balance weight inserted into the wheel by a corresponding weight and an attachment-type balance weight recently used from a small vehicle to a large vehicle and attached to the wheel by a corresponding weight.

Recently, as the attachment-type balance weight, a balance weight made of a polymer material having a band shape to have flexibility, wound in a roll form in a state in which an adhesive layer is formed on one side surface and a release paper is attached to the adhesive layer, cut from the roll form by a required amount, and then attached to an inner peripheral surface of the wheel has been disclosed.

However, since a work of attaching the balance weight as described above is manually performed by a worker, an excessive load may be repeatedly applied to fingers of the worker to cause a work environment problem, for example, musculoskeletal disorders of the worker. Therefore, a phenomenon that the worker avoids the work has occurred, and particularly, it is difficult to secure adhesion quality of the balance weight due to insufficient pressurization force of the balance weight caused by a manual work.

### SUMMARY

The present disclosure provides an automatic wheel balance weight attaching system having advantages of improving work efficiency, decreasing a production cost, and more precisely maintaining a balance of a wheel by cutting a balance weight wound in a band shape at a predetermined length and automatically attaching the cut balance weight to an inner side of the wheel.

An exemplary form of the present disclosure provides an automatic wheel balance weight attaching system including: a weight supplying apparatus supplying a balance weight; a weight cutting apparatus cutting the balance weight supplied from the weight supplying apparatus at a predetermined length; a wheel loading apparatus loading a wheel to a preset position; and a weight attaching apparatus attaching the cut balance weight to one side of an inner peripheral surface of the loaded wheel.

The weight supplying apparatus may include: a rewinding roller rotatably disposed so that the balance weight is wound therearound or unwound therefrom; a feeding roller pulling and drawing out the balance weight so that the balance weight is drawn out from the rewinding roller; and first and second weight detecting sensors each measuring a maximum value and a minimum value corresponding to a margin amount of the balance weight.

The weight cutting apparatus may include: a weight guide guiding movement of the balance weight; a blade disposed at an outlet side of the weight guide to cut the balance weight; a cutting motor moving the blade to allow the blade to cut the balance weight; and a cutting guide guiding the movement of the blade along a predetermined route.

The automatic wheel balance weight attaching system may further include: a weight supplying roller controlling the movement of the balance weight supplied to the blade; a servo-motor providing a torque to be transferred to the weight supplying roller; and a chain connecting a sprocket connected to the servo-motor and a sprocket connected to the weight supplying roller to each other so as to transfer the torque from the servo-motor to the weight supplying roller.

The automatic wheel balance weight attaching system may further include: a release paper removing apparatus removing release paper attached onto one surface of the balance weight, wherein the release paper removing apparatus includes: a release paper recovering roller disposed so as to wind the release paper separated from the balance weight; and a tension adjusting pendulum adjusting tension of the release paper disposed between the release paper recovering roller and the balance weight and wound around the release paper recovering roller using gravity.

The wheel loading apparatus may include: a transferring roll having the wheel disposed thereabove and rotating so that the wheel is transferred; a frame in which the transferring roll is rotatably disposed; and a fixing part mounted in the frame and closely adhering to an outer peripheral surface of the wheel to fix the wheel.

The weight attaching apparatus may include: a robot arm of which movement is controlled by a robot; a bracket rotatably disposed at a front end portion of the robot arm; an upper gripper and a lower gripper each disposed at one side and the other side of an upper portion of the bracket, the balance weight cut in the weight cutting apparatus being attached to the upper gripper and the lower gripper; and elastic members each interposed between one side of the bracket and the upper gripper and between the other side of the bracket and the lower gripper so that the upper gripper and the lower gripper elastically closely adhere to the inner peripheral surface of the wheel.

The weight attaching apparatus may further include a bracket rotating part disposed at the robot arm to rotate the bracket.

Magnets generating magnetic force so that one surface of the balance weight is attached to the upper gripper and the lower gripper may be disposed on the lower gripper and the upper gripper.

An adhesive member attached to the inner peripheral surface of the wheel may be applied onto the other surface of the balance weight.

A portion of the weight supplying roller contacting the balance weight may be made of a polymer compound.

The weight supplying apparatus may further include: a roller transferring part reciprocating the rewinding roller along a rotation center of the rewinding roller when the balance weight is unwound from the rewinding roller.

In the automatic wheel balance weight attaching system according to an exemplary form of the present disclosure, the weight supplying apparatus may stably supply the balance weight, the weight cutting apparatus may more effectively cut the balance weight, and the weight attaching apparatus may more effectively attach the balance weight to a predetermined position of the wheel.

In addition, the first and second weight detecting sensors may stably maintain an amount of supplied balance weight between a minimum value and a maximum value.

Further, the weight guide may precisely guide a direction in which the balance weight moves, thereby allowing the balance weight to be more stably cut.

Further, the servo-motor and the weight supplying roller may be connected to each other through the sprockets and the chain, thereby more precisely controlling rotation of the weight supplying roller without rotation loss.

In addition, the release paper removing apparatus may stably maintain predetermined tension in the release paper through the tension adjusting pendulum, thereby allowing the release paper to be easily separated from the balance weight.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings in which:

FIG. 1 is a schematic view of an automatic wheel balance weight attaching system according to one form of the present disclosure;

FIG. 2 is an entire perspective view of the automatic wheel balance weight attaching system according to an exemplary form of the present disclosure;

FIG. 3 is a schematic side view of a weight supplying apparatus in the automatic wheel balance weight attaching system according to an exemplary form of the present disclosure;

FIG. 4 is a partial perspective view of a weight cutting apparatus in the automatic wheel balance weight attaching system according to another form of the present disclosure;

FIG. 5 is a partial side view showing a release paper removing apparatus in the automatic wheel balance weight attaching system according to an exemplary form of the present disclosure; and

FIG. 6 is a partial perspective view of a weight attaching apparatus in the automatic wheel balance weight attaching system according to an exemplary form of the present disclosure.

The drawings described herein are for illustration purposes only and are not intended to limit the scope of the present disclosure in any way.

### DETAILED DESCRIPTION

The following description is merely exemplary in nature and in not intended to limit the present disclosure, application or uses. It should be understood that throughout the drawings, corresponding reference numerals indicate like or corresponding parts and features.

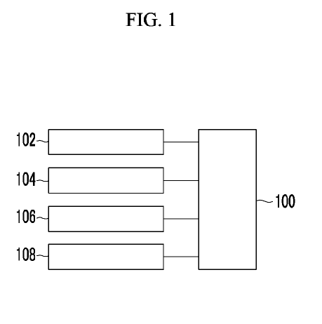

FIG. 1 is a schematic view of an automatic wheel balance weight attaching system according to an exemplary form of the present disclosure.

Referring to FIG. 1, an automatic wheel balance weight attaching system 100 is configured to include a weight supplying apparatus 102, a weight cutting apparatus 104, a weight attaching apparatus 106, and a wheel loading apparatus 108.

The weight supplying apparatus 102 serves to automatically and stably supply a balance weight 220 wound around a roll like a skein, and the weight cutting apparatus 104 serves to cut the balance weight 220 continuously supplied from the weight supplying apparatus 102 at a predetermined length and weight.

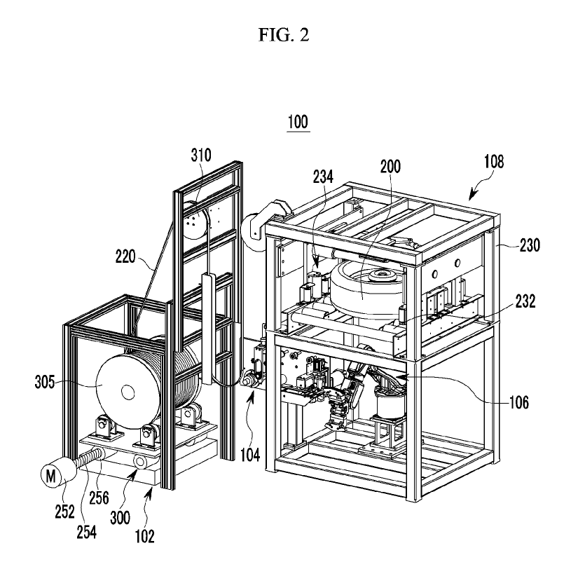

In addition, the wheel loading apparatus 108 serves to move a wheel 200 to a predetermined position through a loading mechanism and fix the wheel, and the weight attaching apparatus 106 serves to attach the cut balance weight 220 to a predetermined position of the wheel 200. A detailed structure will be described with reference to FIGS. 2 to 6.

FIG. 2 is an entire perspective view of the automatic wheel balance weight attaching system according to an exemplary form of the present disclosure.

Referring to FIG. 2, the weight supplying apparatus 102 includes the balance weight 220, a rewinding roller 305, and a feeding roller 310, and the wheel loading apparatus 108 includes a frame 230, a wheel 200, a wheel transferring roller 232, and a wheel fixing part 234.

The balance weight 220 is wound around the rewinding roller 305 like a skein, and the feeding roller 310 draws out the balance weight 220 wound around the rewinding roller 305. In addition, the rewinding roller 305 may be rewound so as to wind the balance weight 220.

In addition, a roller transferring part 250 moving the rewinding roller 305 in an axial direction depending on rotation of the rewinding roller 305 is disposed below the rewinding roller 305.

In an exemplary form of the present disclosure, the roller transferring part 250 has a structure in which it moves so that the balance weight 220 wound around the rewinding roller 305 is stably supplied to the feeding roller 310, and may include a roller transferring motor 252, a screw 254, and a linear bearing 256.

The wheel 200 is loaded to an upper portion of the frame 230 along the wheel transferring roller 232, the wheel fixing part 234 fixes an outer side of the wheel 200, and the weight attaching apparatus 106 attaches the balance weight 220 cut in the weight cutting apparatus 104 to a predetermined position of the wheel 200.

The weight attaching apparatus 106 is disposed at a lower portion of the frame 230 and attaches the balance weight 220 cut in the weight cutting apparatus 104 to one side of an inner peripheral surface of the wheel 200.

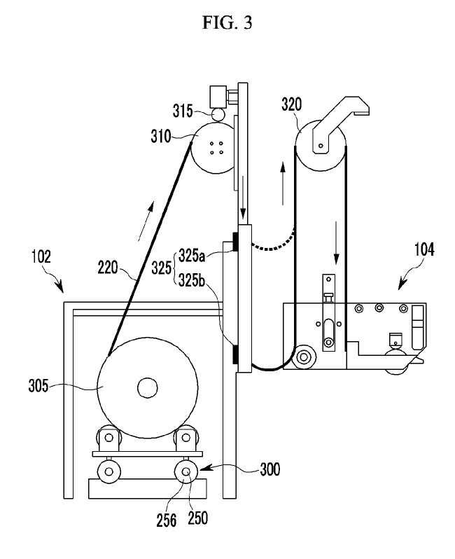

FIG. 3 is a schematic side view of a weight supplying apparatus in the automatic wheel balance weight attaching system according to an exemplary form of the present disclosure.

Referring to FIG. 3, a compressing roller 315 is disposed on an outer peripheral surface of the feeding roller 310, and the balance weight 220 is drawn out between the compressing roller 315 and the feeding roller 310. In addition, a first weight detecting sensor 325a and a second weight detecting sensor 325b are disposed below the feeding roller 310 so as to be spaced apart from each other by a predetermined distance in a vertical direction.

When the feeding roller 310 rotates by a feeding motor (not shown), the balance weight 220 is supplied between the compressing roller 315 and the feeding roller 310 and moves downwardly by gravity. In addition, the second weight detecting sensor 325b detects the balance weight 220 to detect a maximum supply amount of the balance weight 220.

In addition, when the balance weight 220 is detected by the second weight detecting sensor 325b, the feeding roller 310 stops its rotation.

As shown, the balance weight 220 is supplied to the weight cutting apparatus 104 through a transferring roller 320, and the balance weight 220 is consumed, such that a length of the balance weight 220 from the feeding roller 310 is decreased up to the first weight detecting sensor 325a.

Therefore, when the balance weight 220 is not detected by the first weight detecting sensor 325a, the feeding roller 310 again rotates to supply the balance weight 220 from the rewinding roller 305.

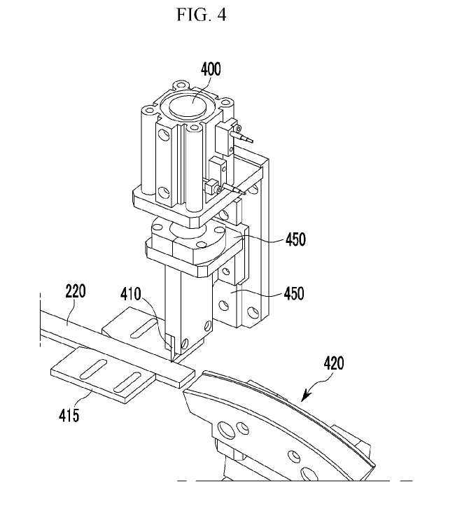

FIG. 4 is a partial perspective view of a weight cutting apparatus in the automatic wheel balance weight attaching system according to an exemplary form of the present disclosure.

Referring to FIG. 4, the weight cutting apparatus 104 includes a cutting motor 400, a cutting guide 405, a blade 410, and a weight guide 415.

A groove through which the balance weight 220 passes is formed in the weight guide 415 to guide movement of the balance weight 220, and the blade 410 is disposed above an outlet side of the weight guide 415 to cut the balance weight 220 supplied from the weight guide 415 at a predetermined length.

The blade 410 has a structure in which it vertically moves by the cutting motor 400, and the cutting guide 405 guides the vertical movement of the blade 410.

The balance weight 220 drawn out from the weight guide 415 is attached onto one surface of a gripper 420, and the blade 410 cuts the balance weight 220 while descending. In addition, the cut balance weight 220 is attached onto one surface of the wheel 200 in a state in which it is attached to the gripper 420.

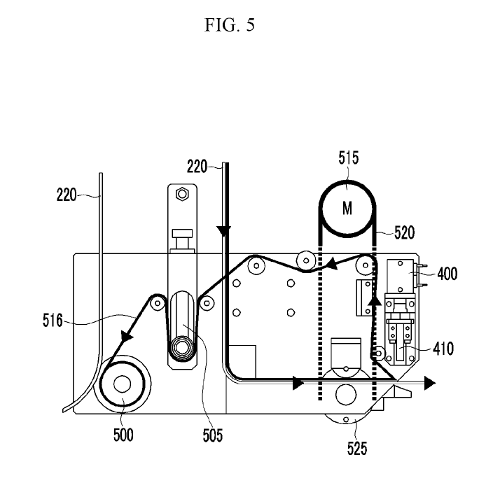

FIG. 5 is a partial side view showing a release paper removing apparatus in the automatic wheel balance weight attaching system according to an exemplary form of the present disclosure.

Referring to FIG. 5, a weight supplying roller 525 is disposed at one side of a lower portion of the release paper removing apparatus, and a servo-motor 515 is disposed above the weight supplying roller 525.

In an exemplary form of the present disclosure, the servo-motor 515 and the weight supplying roller 525 are connected to each other through sprockets and a chain 520, such that rotation of the servo-motor 515 is transferred to the weight supplying roller 525 without being lost, thereby making it possible to improve entire supplying precision.

In addition, a release paper recovering roller 500 is disposed at a rear side of the weight supplying roller 525. The release paper recovering roller 500 serves to detach release paper from an upper surface of the balance weight 220 drawn out from the weight supplying roller 525, and a tension adjusting pendulum 505 is disposed in front of the release paper recovering roller 500.

The tension adjusting pendulum 505 maintains predetermined tension in the release paper 510 between the release paper recovering roller 500 and the balance weight 220 to allow the release paper 510 to be easily separated from the balance weight 220.

In an exemplary form of the present disclosure, the tension adjusting pendulum 505, which adds tension to the release paper 510 by gravity, has a tension roller mounted at a lower end portion thereof, and has a structure in which the tension roller presses the release paper 510 downwardly.

In addition, a weight of the balance weight depending on a length of the balance weight is set using an encoder value of the servo-motor, and an outer peripheral surface of the weight supplying roller may be made of a polymer compound (for example, a urethane material) in order to prevent sliding between the balance weight and the weight supplying roller.

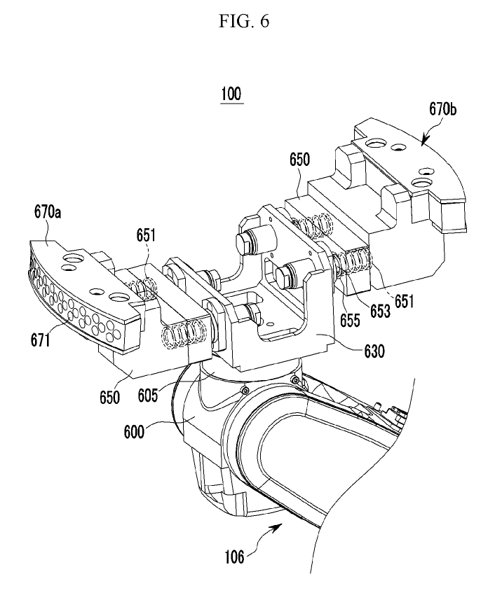

FIG. 6 is a partial perspective view of a weight attaching apparatus in the automatic wheel balance weight attaching system according to an exemplary form of the present disclosure.

Referring to FIG. 6, the weight attaching apparatus 106 includes a robot arm 600 connected to a robot, a rotating member 605 rotatably disposed at one side of the robot arm 600, a bracket 630 disposed above the rotating member 605, support blocks 650 disposed so as to be spaced apart from both sides of the bracket 630 by a predetermined distance, and a lower gripper 670a and an upper gripper 670b disposed at outer sides of the support blocks 650, respectively.

Magnets 671 to which the balance weight 220 is attached by magnetic force are disposed on outer surfaces of the lower gripper 670a and the upper gripper 670b, and elastic members 651 are interposed between the support blocks 650 and the bracket 630.

Front end portions of the elastic members 651 are inserted into grooves 655 formed in the support blocks 650, and the upper gripper 670b and the lower gripper 670a have a structure in which distances between the upper and lower grippers 670b and 670a and the bracket 630 are adjusted depending on guide members 653.

In addition, the elastic members 651 are compressed or extended and allow the upper gripper 670b or the lower gripper 670a to elastically closely adhere to one surface of the wheel 200, depending on a distance from the upper gripper 670b or the lower gripper 670a to the bracket 630.

Further, the rotating member 605 may rotate at the robot arm 600 by a bracket rotating part 680 to rotate the upper gripper 670b and the lower gripper 670a and attach the balance weight 220 to a predetermined rotation position of the wheel 200.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the appended claims.

<Description of Symbols>

100: automatic wheel balance weight attaching system 102: weight supplying apparatus

| | |
|---|---|
| 104: weight cutting apparatus | 106: weight attaching apparatus |
| 108: wheel loading apparatus | 200: wheel |
| 220: balance weight | 230: frame |
| 232: wheel transferring roller | 234: wheel fixing part |
| 250: roller transferring part | 252: roller transferring motor |
| 254: screw | 256: linear bearing |
| 305: rewinding roller | 310: feeding roller |
| 315: compressing roller | 320: transferring roller |
| 325a: first weight detecting sensor | |
| 325b: second weight detecting sensor | |
| 325: weight detecting sensor | 400: cutting motor |
| 405: cutting guide | 410: blade |
| 415: weight guide | 420: gripper |
| 505: tension adjusting pendulum | 510: release paper |
| 515: servo-motor | 520: chain |
| 525: weight supplying roller | 600: robot arm |
| 605: rotating member | 630: bracket |
| 650: support block | 651: elastic member |
| 653: guide member | 655: groove |
| 670a,b: lower, upper gripper | 671: magnet |
| 680: bracket rotating part | |

What is claimed is:

1. An automatic wheel balance weight attaching system comprising:
a weight supplying apparatus configured to supply a balance weight;
a weight cutting apparatus configured to cut the balance weight supplied from the weight supplying apparatus at a predetermined length;
a wheel loading apparatus configured to load a wheel to a preset position; and
a weight attaching apparatus configured to attach the cut balance weight to one side of an inner peripheral surface of the loaded wheel.

2. The automatic wheel balance weight attaching system according to claim 1, wherein the weight supplying apparatus comprises:
a rewinding roller rotatably disposed so that the balance weight is wound therearound or unwound therefrom;
a feeding roller pulling and drawing out the balance weight so that the balance weight is drawn out from the rewinding roller; and
first and second weight detecting sensors each measuring a maximum value and a minimum value corresponding to a margin amount of the balance weight.

3. The automatic wheel balance weight attaching system according to claim 1, wherein the weight cutting apparatus comprises:
a weight guide configured to guide a movement of the balance weight;
a blade disposed at an outlet side of the weight guide to cut the balance weight;
a cutting motor configured to move the blade to allow the blade to cut the balance weight; and
a cutting guide configured to guide the movement of the blade along a predetermined route.

4. The automatic wheel balance weight attaching system according to claim 3, further comprising:
a weight supplying roller configured to control the movement of the balance weight supplied to the blade;
a servo-motor configured to provide a torque to be transferred to the weight supplying roller; and
a chain connecting a sprocket connected to the servo-motor and a sprocket connected to the weight supplying roller to each other so as to transfer the torque from the servo-motor to the weight supplying roller.

5. The automatic wheel balance weight attaching system according to claim 1, further comprising a release paper removing apparatus configured to remove a release paper attached onto one surface of the balance weight,
wherein the release paper removing apparatus comprises:
a release paper recovering roller disposed so as to wind the release paper separated from the balance weight; and
a tension adjusting pendulum configured to adjust a tension of the release paper disposed between the release paper recovering roller and the balance weight and the release paper wound around the release paper recovering roller using gravity.

6. The automatic wheel balance weight attaching system according to claim 1, wherein the wheel loading apparatus comprises:
a transferring roll having the wheel disposed thereabove and rotating so that the wheel is transferred;
a frame in which the transferring roll is rotatably disposed; and
a fixing part mounted in the frame and closely adhering to an outer peripheral surface of the wheel to fix the wheel.

7. The automatic wheel balance weight attaching system according to claim 1, wherein the weight attaching apparatus comprises:
a robot arm of which movement is controlled by a robot;
a bracket rotatably disposed at a front end portion of the robot arm;
an upper gripper disposed on a first side of an the bracket and a lower gripper disposed on a second side of the bracket, the balance weight cut in the weight cutting apparatus being attached to the upper gripper and the lower gripper; and
elastic members each interposed between the first side of the bracket and the upper gripper and between the second side of the bracket and the lower gripper so that the upper gripper and the lower gripper elastically closely adhere to the inner peripheral surface of the wheel.

8. The automatic wheel balance weight attaching system according to claim 7, wherein the weight attaching apparatus further comprises a bracket rotating part disposed at the robot arm to rotate the bracket.

9. The automatic wheel balance weight attaching system according to claim 7, wherein:
magnets generating magnetic force so that one surface of the balance weight is attached to the upper gripper and the lower gripper are disposed on the lower gripper and the upper gripper.

10. The automatic wheel balance weight attaching system according to claim 9, wherein an adhesive member attached to the inner peripheral surface of the wheel is applied onto another surface of the balance weight.

11. The automatic wheel balance weight attaching system according to claim 4, wherein a portion of the weight supplying roller contacting the balance weight is made of a polymer compound.

12. The automatic wheel balance weight attaching system according to claim 2, wherein the weight supplying apparatus further comprises a roller transferring part reciprocating the rewinding roller along a rotation center of the rewinding roller when the balance weight is unwound from the rewinding roller.

13. An automatic wheel balance weight attaching system comprising:
a weight supplying apparatus configured to supply a balance weight;
a weight cutting apparatus configured to cut the balance weight supplied from the weight supplying apparatus at a predetermined length;
a wheel loading apparatus configured to load a wheel to a preset position; and
a weight attaching apparatus configured to attach the cut balance weight to one side of an inner peripheral surface of the loaded wheel,
wherein the weight cutting apparatus comprises:
a blade disposed so as to cut the balance weight; and
a cutting motor configured to move the blade to allow the blade to cut the balance weight.

14. The automatic wheel balance weight attaching system according to claim 13, further comprising:
a weight supplying roller configured to control a movement of the balance weight supplied to the blade;
a servo-motor configured to provide a torque to be transferred to the weight supplying roller; and
a chain connecting a sprocket connected to the servo-motor and a sprocket connected to the weight supplying roller to each other so as to transfer the torque from the servo-motor to the weight supplying roller.

15. The automatic wheel balance weight attaching system according to claim 13, further comprising:
a release paper removing apparatus configured to remove a release paper attached onto one surface of the balance weight,
wherein the release paper removing apparatus comprises:
a release paper recovering roller disposed so as to wind the release paper separated from the balance weight; and
a tension adjusting pendulum configured to adjust a tension of the release paper disposed between the release paper recovering roller and the balance weight and the release paper wound around the release paper recovering roller using gravity.

16. The automatic wheel balance weight attaching system according to claim 13, wherein the weight attaching apparatus comprises:
a robot arm of which movement is controlled by a robot;
a bracket rotatably disposed at a front end portion of the robot arm;
an upper gripper disposed on a first side of the bracket and a lower gripper disposed on a second side of the bracket, the balance weight cut in the weight cutting apparatus being attached to the upper gripper and the lower gripper; and
elastic members each interposed between the first side of the bracket and the upper gripper and between the second side of the bracket and the lower gripper so that the upper gripper and the lower gripper elastically closely adhere to the inner peripheral surface of the wheel.
